(19) United States
(12) Patent Application Publication
(10) Pub. No.: US 2006/0085573 A1
(43) Pub. Date: Apr. 20, 2006

(54) Multi-context selection with PCI express to support hardware partitioning

(75) Inventors: Jimmy D. Pike, Georgetown, TX (US); Frank H. Molsberry II, Georgetown, TX (US)

Correspondence Address: Ann C. Livingston;Baker Botts L.L.P., One Shell Plaza, 910 Louisiana, Houston, TX, 77002-4995, US

(73) Assignee: Dell Products L.P., Round Rock, TX (US)

(21) Appl. No.: 10/966,952

(22) Filed: Oct. 15, 2004

(51) Int. Cl. G06F 3/06

(52) U.S. Cl. 710/36

(57) ABSTRACT

A system and method for hardware partitioning of an information handling system. The partitioning is through the CPU, memory, and I/O systems. This is accomplished by providing multiple contexts for each I/O device (one for each partition), and by using the transaction ID field of the PCI Express bus packet header to map an I/O device to a context.

### TECHNICAL FIELD

This invention relates to information handling systems, and more particularly to hardware partitioning of such systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems become more complex, issues such as security and resource allocation become paramount. One area of concern is the separation of multiple workloads on a single machine. This problem is addressed with hardware partitioning, which provide distinct execution environments on a single machine.

Hardware partitioning can be of the CPU and/or memory, and optionally through to the I/O system. In today's computer systems, partitioning that extends through the I/O system (“through the edge of the system”) is more difficult to achieve than are CPU and memory partitioning.

One approach to I/O partitioning is to provide separate I/O devices for each hardware partition. However, this results in expensive hardware replication.

### SUMMARY

In accordance with teachings of the present disclosure, a system and method are described for “to the edge” hardware partitioning. That is, multiple partitions are created for I/O devices.

The information handling system is partitioned into a number of partitions, each partition having a CPU system, a memory system, and an I/O system. The I/O system is connected to the rest of the system by means of a PCI Express bus. Each I/O device has a hardware context, comprising a set of one or more registers for each partition. Partitioning of the I/O system is performed by using the transaction ID portion of a PCI Express packet header to map an I/O device to the context of a desired partition.

By using the transaction ID field of the PCI express packet header for partition selection, hardware partitioning can be accomplished to the edge of the computer system. This is accomplished using existing PCI Express protocol. Actual implementation may involve clarification or re-definition of existing fields, but the basic protocol is unchanged.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system in which the CPU and memory, but not the I/O system, are partitioned.

FIG. 2 illustrates the system of FIG. 1, but with the I/O system also partitioned.

FIG. 3 illustrates multi-context partitioning in accordance with the invention.

FIG. 4 illustrates the PCI express packet format.

FIG. 5 illustrates the packet header format of the PCI packets of FIG. 4.

### DETAILED DESCRIPTION

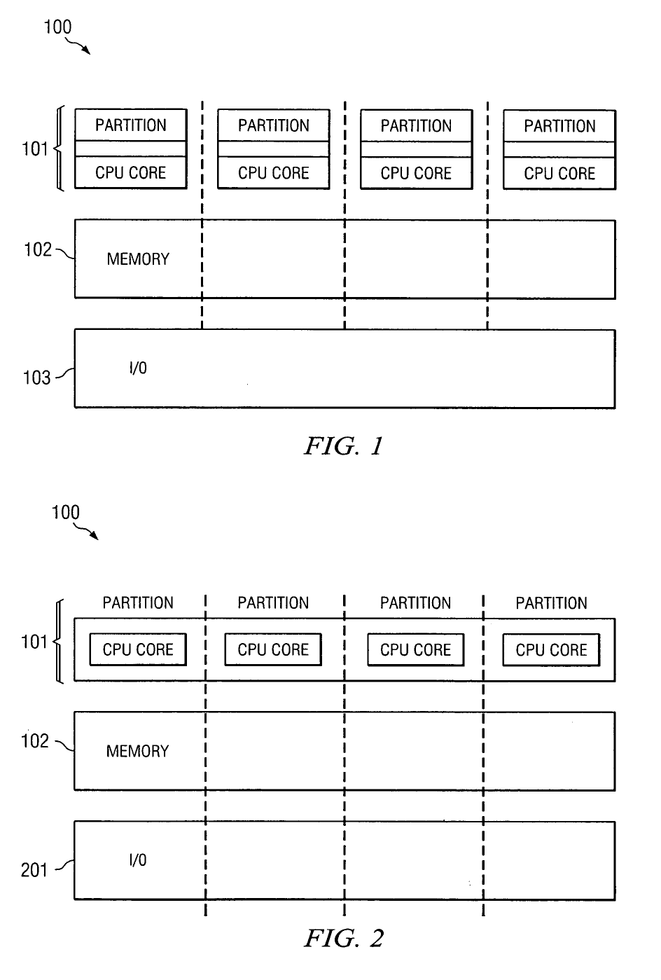

Preferred embodiments and their advantages are best understood by reference to FIGS. 1 through 5, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 1 illustrates an information handling system 100 having partitioned resources, but in which the partitioning does not extend to the I/O devices. Specifically, system 100 has its CPU 101 and memory 102 in four partitions. The separation of the partitions is enforced by the CPU and its associated chipset. This separation isolates each CPU 101 and its associated memory 102.

For purposes of this description, CPU 101 can comprise a single partitioned processor or multiple processors. For example, a system 100 having multiple server CPU devices, can be partitioned in accordance with the system and method described herein.

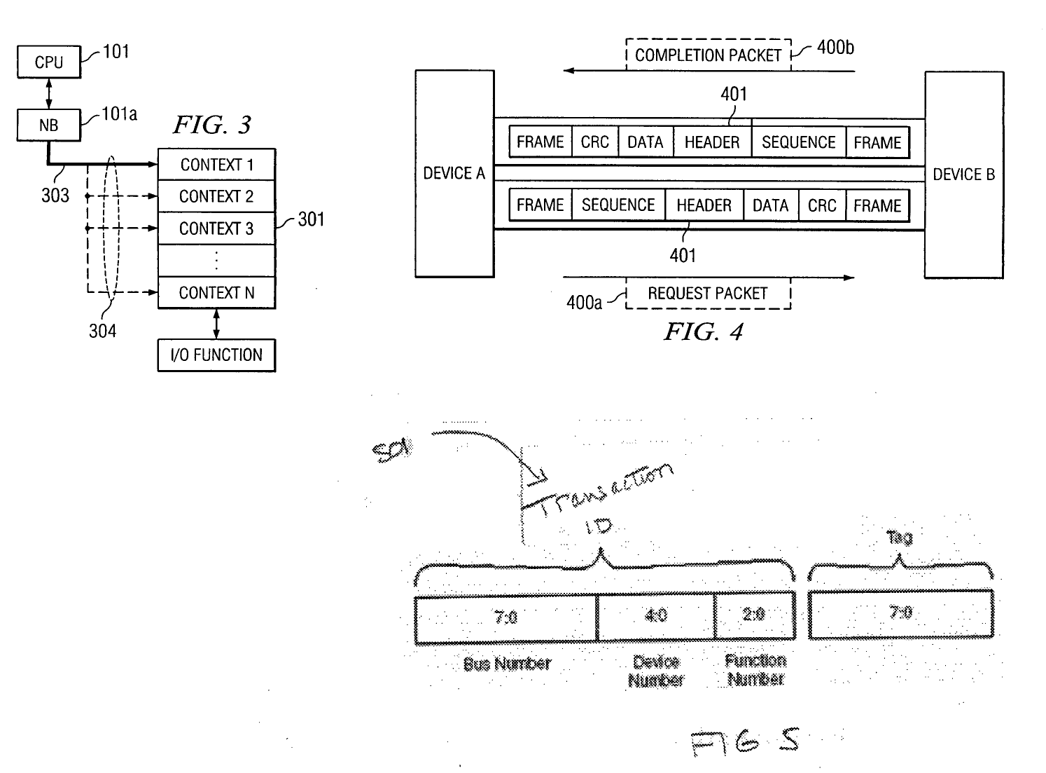

As explained in the Background, the partitions provide distinct execution environments within system 100. However, in FIG. 1, this separation does not extend to the I/O system 103. For purposes of this description, the I/O system 103 may include interfaces for any number of input and output devices. As explained below in connection with FIGS. 3-5, it is assumed that these devices communicate with the rest of system 100 by means of a PCI Express bus.

FIG. 2 illustrates the same system as FIG. 1, but with a partitioned I/O system 201. In other words, isolation of the partitions is complete “to the edge” of system 100.

FIG. 3 illustrates the use of contexts for partitioning I/O system 201 in accordance with the invention. As explained below, the use of contexts ensures that the existing programming model for system 100 remains intact. This eliminates I/O impact from the partitioning and permits existing I/O drivers to be used.

In FIG. 3, CPU 101, as in FIGS. 1 and 2, is capable of supporting partitions. Its associated chipset includes a northbridge 101a, having the conventional northbridge functions known in the field of processing devices.

To create isolation of the partitions of I/O system 201, each I/O device presents a private programming model for each partition from which a host attempts to use that device. “Programming model” means the control registers, etc., that make up the normal programming interface normally seen when using that device. The I/O device is required to manage the application of the correct information presented from each partition and used by the underlying functions.

The register sets that are owned exclusively by a host in a partition are referred to herein as “contexts”. By creating multiple contexts for I/O devices, each context corresponding to a unique operating system instance, I/O partitions can be created.

As stated above, it is assumed that the bus between the northbridge 101a is a PCI (Peripheral Component Interconnect) Express bus 303. Bus 303 is a local I/O bus, which connects various peripheral devices to the memory, chipset, and processor. Video cards, disk storage devices, and network interface cards are examples of peripheral devices that use this bus.

The PCI Express bus 303 is the current generation of the PCI bus family. This bus 303 is a high-bandwidth serial bus, which maintains software compatibility with existing PCI devices. Data is encapsulated into packets and sent as a serial stream on the link to/from an I/O device. The packets contain information such as the destination address, amount of data being sent or being read, CRC, and a command.

FIGS. 4 and 5 illustrate PCI Express packets 400a and 400b, and packet format of the serial bit stream format for the PCI Express bus programming model. Both a request packet 400a and a completion packet 400b are shown. Each packet contains a header portion 401.

Referring in particular to FIG. 5, the 256 byte header 401 provides for compatibility with prior PCI and PCI-X bus standards. As indicated, bytes 4-7, 10, and 11 may vary depending on the type of packet, that is, the transaction layer type. Certain fields in bytes 0-3 are reserved fields, as indicated by “R”.

However, all packet headers 401 contain a transaction ID field 501. The transaction ID field 501 identifies the bus number, device number, and function number. In a requester packet, the transaction ID field 501 comprises bytes 8 and 9 of the packet header 401.

Referring again to FIG. 3, I/O devices equipped with multiple contexts support the transaction ID field 501. The use of field 501 may be used to map a context to a partition of system 100. A hypervisor function of CPU 101 can be used as a control mechanism 304 to define partition selection.

Although the disclosed embodiments have been described in detail, it should be understood that various changes, substitutions and alterations can be made to the embodiments without departing from their spirit and scope.

What is claimed is:

1. An information handling system, in which hardware is partitioned through the I/O system, comprising:
a CPU system having a number of hardware partitions;
a memory system having the same number of hardware partitions;
a I/O system having the same number of hardware partitions, and having at least one I/O device;
wherein each I/O device has a hardware context, comprising one or more memory storage elements, in each partition;
wherein the I/O system is connected to the CPU system by means of a PCI Express bus; and
wherein partitioning of the I/O system is performed by using at least part of the requester ID portion of a PCI Express packet header to map an I/O device to the context of a desired partition.

2. The system of claim 1, wherein each hardware context comprises at least one register.

3. The system of claim 1, wherein the CPU system comprises a single partitioned CPU.

4. The system of claim 1, wherein the CPU system comprises multiple CPUs.

5. The system of claim 1, wherein the CPU system comprises multiple server CPUs.

6. The system of claim 1, wherein the CPU system has a northbridge for handling communications via the PCI Express bus.

7. The system of claim 1, wherein the CPU is programmed to define a control structure for partition selection.

8. The system of claim 7, wherein the control structure is implemented with a hypervisor function of the CPU.

9. A method of partitioning an information handling system having at least a CPU system, memory system, and I/O system, such that hardware is partitioned through the I/O system, comprising:
partitioning a CPU system into hardware partitions;
partitioning the memory system into hardware partitions;
partitioning the I/O system into hardware partitions;
wherein the I/O system has at least one I/O device;
wherein each I/O device has a hardware context, comprising one or more memory storage elements, in each partition;
wherein the I/O system is connected to the CPU system by means of a PCI Express bus; and
wherein partitioning of the I/O system is performed by using at least part of the requester ID portion of a PCI Express packet header to map an I/O device to the context of a desired partition.

10. The method of claim 9, wherein each hardware context comprises at least one control register.

11. The method of claim 9, wherein the CPU system comprises a single partitioned CPU.

12. The method of claim 9, wherein the CPU system comprises multiple CPUs.

13. The method of claim 9, wherein the CPU system comprises multiple server CPUs.

14. The method of claim 9, wherein the CPU system has a northbridge for handling communications via the PCI Express bus.

15. The method of claim 9, further comprising programming the CPU to define a control structure for partition selection.

16. The method of claim 15, wherein the control structure is implemented with a hypervisor function of the CPU.
